(19) United States
(12) Patent Application Publication
(10) Pub. No.: US 2013/0091295 A1
(43) Pub. Date: Apr. 11, 2013

(54) PUBLISH/SUBSCRIBE SYSTEM INTEROPERABILITY

(71) Applicants: Henricus Johannes Maria Meijer, Mercer Island, WA (US); Dragos Manolescu, Kirkland, WA (US)

(72) Inventors: Henricus Johannes Maria Meijer, Mercer Island, WA (US); Dragos Manolescu, Kirkland, WA (US)

(73) Assignee: MICROSOFT CORPORATION, Redmond, WA (US)

(21) Appl. No.: 13/267,040

(22) Filed: Oct. 6, 2011

(51) Int. Cl. G06F 13/00; G06F 15/16

(52) U.S. Cl. 709/231

(57) ABSTRACT

Publish/subscribe (pub/sub) systems can be interoperable. Differences between various pub/sub systems can be addressed to enable creative combination of streams from diverse pub/sub systems, among other things. More specifically, pub/sub systems can be unified to facilitate interaction, and adjustments can be made to compensate for any message stream idiosyncrasies.

### BACKGROUND

Publish/subscribe (pub/sub) systems are popular at least because of loose coupling amongst entities. Publishers send messages and subscribers receive the messages. However, publishers and subscribers need not run in the same address space, machine, or network (and typically do not). Further, publishers and subscribers need not run at the same time, and communication between publishers and subscribers is asynchronous. In other words, publishers and subscribers can be decoupled in space, time, and execution dimensions. Still further, publishers and subscribers need not know anything about one another to communicate. As a result, publishers and subscribers are loosely coupled as opposed to tightly coupled as in a traditional client-server architecture. Consequently, publishers and subscribers can operate substantially independent of each other as well as a particular system topography.

Many pub/sub systems employ an intermediary broker to enable communication amongst loosely coupled publishers and subscribers. Here, a publisher provides messages to an intermediate broker and a subscriber registers subscriptions with the broker. The broker can select and route messages from a publisher to a subscriber. In one instance, selection can involve filtering messages to identify a relevant subset of messages that are of interest to a subscriber. A well-known example of such a pub/sub system is Twitter®. Here, text-based messages of users, called “tweets,” are published and users can subscribe to and receive messages of other users, called “following.” Other pub/sub systems implementations include PubSubHubbub, .Net Service, and JMS (Java Message Service), among many others.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to publish/subscribe (pub/sub) system interoperability. Differences between various pub/sub systems can be addressed to enable creative combination of message streams from diverse pub/sub systems, among other things. In accordance with one embodiment, representations of pub/sub systems can be unified to facilitate uniform interaction, for example by employing a uniform interface over diverse pub/sub systems. Further, adjustments can be made to compensate for any message stream idiosyncrasies where present, for instance by using query specified transformations.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system facilitates interoperability amongst publish/subscribe systems.

FIG. 2 is a block diagram of transformation system.

FIG. 3 is a block diagram of a composition system.

FIGS. 4-6 illustrate exemplary pub/sub scenarios.

FIG. 7 is a flow chart diagram of a method of facilitating interoperability amongst publish/subscribe systems.

FIG. 8 is a flow chart diagram of a method of transformation.

FIG. 9 is a schematic block diagram illustrating a suitable operating environment for aspects of the subject disclosure.

### DETAILED DESCRIPTION

Details below are generally directed toward publish/subscribe (pub/sub) system interoperability. Many pub/sub systems, or in other words pub/sub system implementations, currently exist (e.g., PubSubHubbub, .Net Service, JMS . . . ). Unfortunately, the diversity of existing pub/sub systems makes interoperability problematic. In accordance with one embodiment, diverse pub/sub systems can be unified to facilitate interaction. As well, adjustments can be made to compensate for any message stream idiosyncrasies. For example, a uniform interface can be employed over pub/sub systems. Additionally, message streams can be processed in a manner that accounts for any differences in streams utilizing queries over message streams. In any event, any impedance mismatch between various concrete pub/sub systems can be removed. Resulting interoperability enables creative combination of message streams from different concrete pub/sub systems, among other things.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

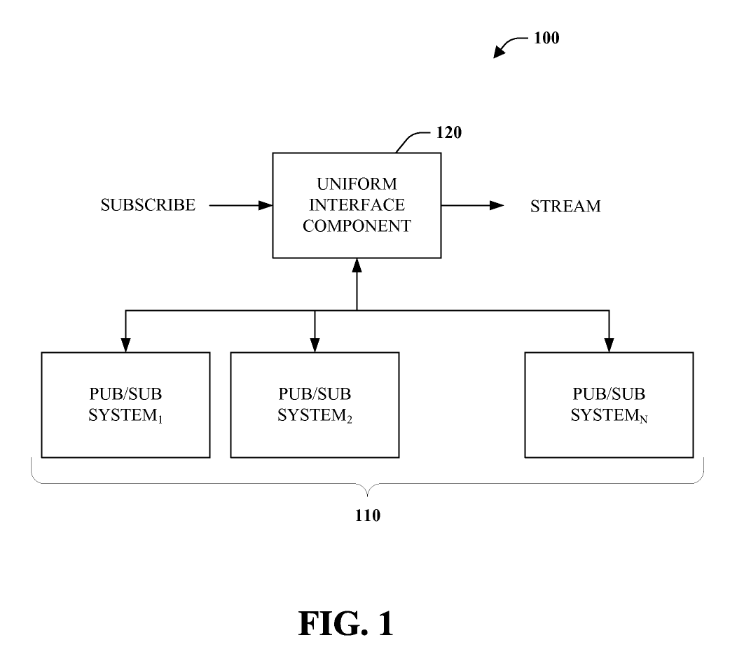

Referring initially to FIG. 1, a system 100 is illustrated that facilitates interoperability amongst publish/subscribe systems. As shown, the system 100 includes numerous publish/subscribe (pub/sub) systems 110 (PUB/SUB SYSTEM₁-PUB/SUB SYSTEM_{N}, where N is an integer greater than one), and uniform interface component 120. A pub/sub system generally refers to a pattern in which a message (e.g., data, error . . . ) is sent by a publisher (sender) to a loosely coupled subscriber (receiver) asynchronously (e.g., at arbitrary times). As used herein and unless otherwise noted, a pub/sub system 110 is intended to refer to a specific implementation of a pub/sub system, or in other words a concrete pub/sub system, rather than a general pattern. For example, a pub/sub system 110 can correspond to implementations including, but not limited to, PubSubHubbub, .Net Service, and JMS (Java Message Service). Accordingly, protocol that governs interaction, among other things, can vary as a function of pub/sub systems 110.

The uniform interface component 120 is configured to enable interaction with diverse pub/sub systems 110 in a uniform manner. For example, rather than dealing with “M” different protocols for interacting with “N” pub/sub systems 110, a single uniform protocol can be employed. In other words, the uniform interface component 120 hides details of each concrete pub/sub system 110 behind an abstraction. Similarly, the uniform interface component 120 can be said to virtualize the underlying pub/sub systems 110. Consequently, streams can be produced and subscribed to in a uniform manner regardless of specifics regarding each pub/sub system 110.

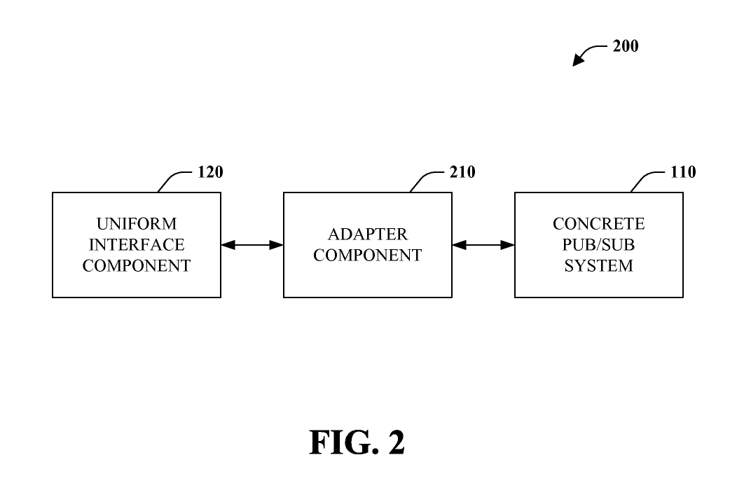

Turning attention briefly to FIG. 2, a transformation system 200 is shown including the uniform interface component 120 and one pub/sub system 110. Differences between the uniform interface component 120 and the pub/sub system 110 can be removed by adapter component 210. In particular, the adapter component 210 can map, or in other words convert, between programmatic operations of the concrete pub/sub system 110 and the uniform interface component 120. In this manner, subscriptions can be provided by way of the uniform interface component 120 and converted into semantically equivalent operations with respect to the concrete pub/sub system 110 by the adapter component 210. Similarly, publication of streams from the pub/sub system 110 can be converted to a form supported by the uniform interface component 120.

As will be discussed further herein, new pub/sub systems can be created utilizing the output of pub/sub systems 110 directly or indirectly. Such pub/sub system implementations can be referred to as subjects, which also operate with respect to uniform interface component 120. By way of example, consider a pub/sub system 110 that stores messages for twenty-four hours. A subject can be created that subscribes to such a pub/sub system stream and publishes a stream that stores messages for longer than twenty-four hours. In other words, a system with limited memory was converted to a system with a longer memory. Furthermore, a pub/sub system in conjunction with a uniform interface component 120 (e.g., uniform interface component 120+ adapter component 210+ concrete pub/sub system 110) can also be referred to as a subject. A unified representation of pub/sub systems can thus be established comprising numerous subjects.

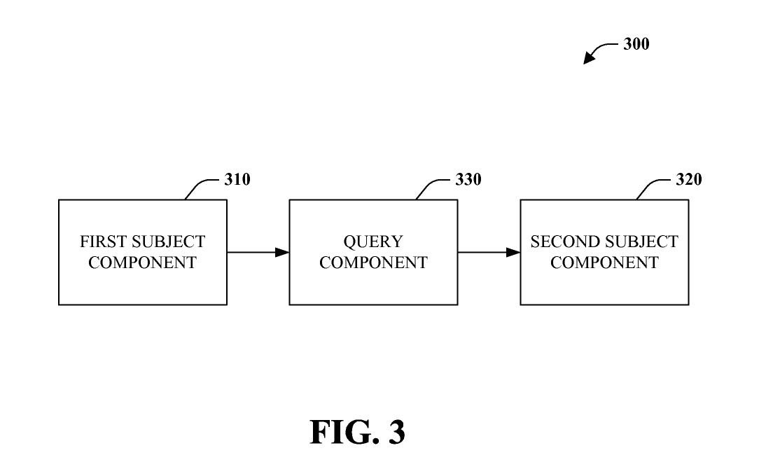

FIG. 3 depicts compositional system 300. A unified representation enables pub/sub systems to be composed, or combined, in created ways. As shown, system 300 includes a first subject component 310. The first subject component 310 corresponds to a unified representation of a first pub/sub system. In accordance with one aspect, the first pub/sub system can be a specific pub/sub system together with the corresponding uniform interface component, among other things. The output of the first subject component 310 is a message stream (collection of values published asynchronously). The first subject component 310 can be utilized to produce the second subject component 320, which corresponds to a unified representation of a second pub/sub system. Query component 330 can connect, or in other words glue, the first subject component 310 to the second subject component 320.

More specifically, the query component 330 can apply a query over the message stream output by the first subject component 310 and provide a resulting message stream as the input to the second subject component 320. The query can provide filtering functionality and well as combination functionality where more than one subject component is utilized as input, among other things. For example, the query component 330 can apply a filter over a stream of stock prices output by the first subject component 310 such that a subset of stock prices are provided corresponding to stocks of particular interest.

The query component 330 can also enable transformational functionality to address idiosyncrasies of a particular subject, for instance. A uniform representation can enable communication, but the resulting stream among other things can differ from a standard format or a canonical format (e.g., typical, usual, regardless of whether format has been standardized). The query component 330 can thus transform the output message stream into an acceptable format. This can be especially helpful if message streams are combined across multiple sources. Here, various formats can be converted into a single format. In accordance with one embodiment and as will be described later herein, the query component 330 can be configured to operate with respect to general-purpose, programming-language—integrated query operators configured to capture functionality including but not limited to projection, filtering, joining, combination, and aggregation.

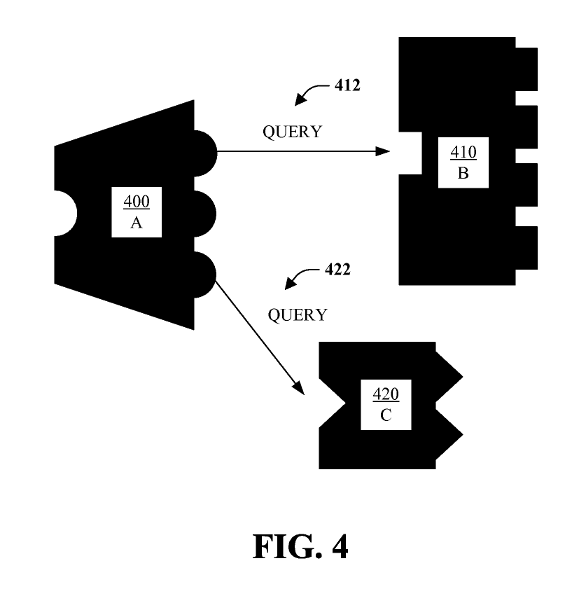

FIG. 4 illustrates an exemplary scenario in accordance various aspects of the disclosed subject matter. The purpose of FIG. 4 is to aid clarity and understanding with respect to disclosed aspects and not to limit the scope of the claimed subject matter in any way. FIG. 4 depicts three subjects, subject A 400, subject B 410, and subject C 420. The varying shapes and sizes of the three subjects capture the fact that these are different subjects. Similarity in concave and convex shapes associated with each subject represents a unified representation, or more specifically, a uniform interface. Differences in the concave and convex shapes symbolize potential varying format or other idiosyncrasies of each subject that may remain despite unifying representations. Here, subject A 400 can represent a pub/sub system wrapped with a uniform interface thereby converting it into a subject. Subject B 410 and subject C 420 denote subjects that are composed from subject A 400. Query 412 connects subject A 400 to subject B 410, and query 422 connects subject A 400 to subject C 420. In accordance with one embodiment, the queries 412 and 422 can address idiosyncrasies between subjects, denoted by the different concave and convex shapes, amongst other functionality such as but not limited to filtering.

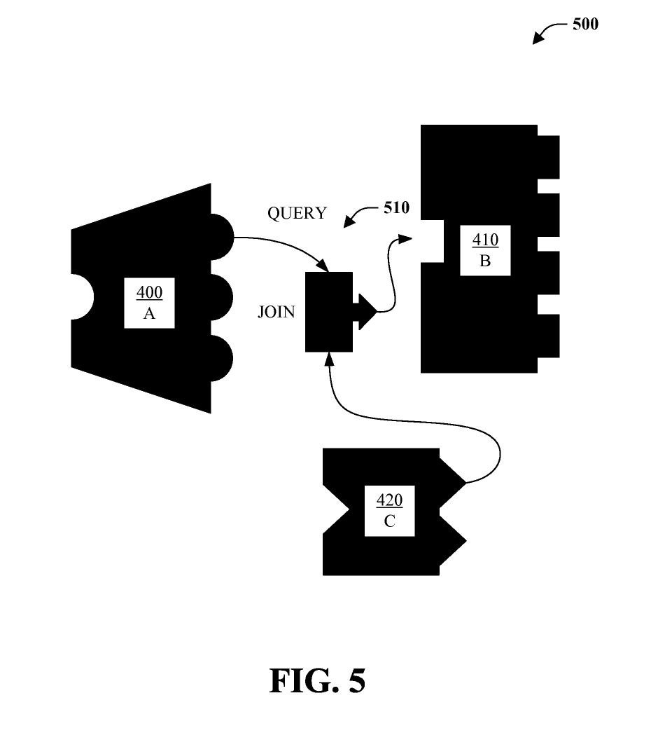

FIG. 5 depicts another exemplary scenario in accordance with aspects of the disclosure. FIG. 5 is similar to FIG. 4 in that includes the three subjects, namely subject A 400, subject B 410, and subject C 420, and representations as described above. The scenario in FIG. 5, however, is slightly more complicated since the output of subject A 400 and subject C 420 is combined to provide the input of subject B 410. Here, query 510, which ties all the subjects together, is a join query that joins message streams from subject A 400 with subject C 420 to produce a single message streams for subject B 410.

In accordance with one embodiment the uniform interface component as described herein can correspond to implementation of continuation-passing style interfaces: “IObserver” and “IObservable,” whose signatures are below:

public interface IObservable<out T>
{

IDisposable Subscribe (IObserver<T> observer);

}
public interface IObserver<in T>
{

void OnNext (T value);
void OnError (Exception exception);
void OnCompleted( );

}

The “IObservable” interface is implemented by a sequence, or collection, to be observed. Its single method “Subscribe” can be utilized to subscribe to an observable collection. The “IObserver” interface is utilized to observe values of the observable collection and receive notifications (e.g., callbacks). More particularly, “OnNext” sends the next value from the collection, “OnError” provides notification of an error/exception, and “OnCompleted” provides notification that the observable collection has finished sending values. In other words, an observable maintains a list of dependent observers that subscribe to the observable and notifies the observers automatically upon state change. Further, an observer can unsubscribe to an observable by calling a function “Dispose” on a disposable object returned upon subscription.

More specifically, the uniform interface described above can correspond to an “ISubject” interface, whose signature is below:
public interface ISubject<TSource, TResult>: IObserver<TSource>, IObservable<TResult>

Note that “ISubject” implements both “IObserver” and “IObservable” as described above. Accordingly, “ISubject” represents an object that is both an observable collection and an observer. With respect to FIGS. 4 and 5, each of the three subjects can implement “ISubject.” In this case, concave shapes correspond to “IObserver” and convex shapes represent “IObserver.”

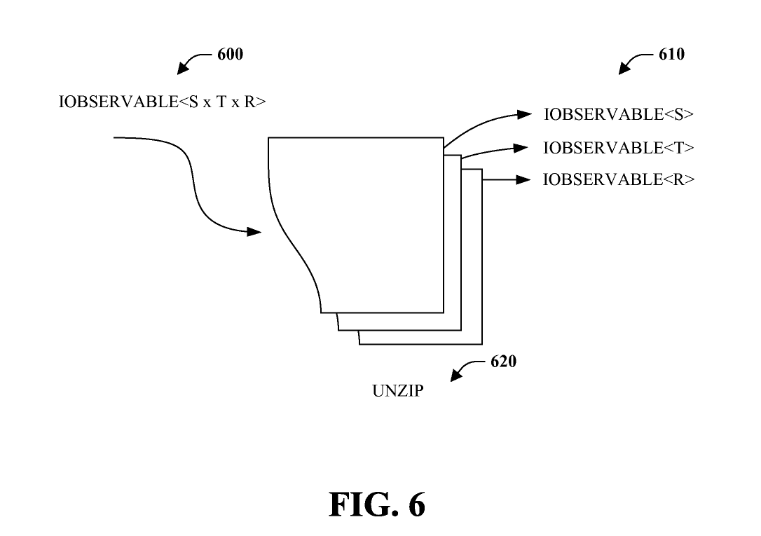

Referring to FIG. 6, yet another exemplar scenario is illustrated. In certain situations, it may be desirable to expose the output of certain subjects as multiple outputs. This can correspond to topic-, content-, or type-based publish subscribe. In the context of the specific interfaces described above, this corresponds to IObservable<S x T x R>600 being mapped to three observables IObservable<S>, IObservable<T>, and IObservable<R>610. The mapping here be provided by an unzip query operator 620. Similarly, transformation of the type “IObservable<S+T>→IObservable<S>×IObservable<T>” that takes a single stream of a disjoint union of values and produces a product of streams.

General-purpose, or generic, language-integrated-query operators can be utilized to manipulate one or more observable collections, such as message streams, produced by a subject. In one embodiment, these query operators can be implemented as extension methods on observable collections, which can be specified in a general-purpose programming language such as C#® or Visual Basic® in dot notation or as a query expression (e.g., SQL (Structured Query Language) like representation). Most operators take a stream, perform some logic (e.g., projection, filter, group, aggregate, partition, join, order . . . ) on it, and output another stream that captures the results of the logic. In addition, multiple operators can be chained together on a source stream to produce specific resulting data stream. Consequently, compositionality is inherently supported.

Aspects of the disclosure exploit loose coupling of pub/sub systems to enable combination of pub/sub systems in creative ways. By way of example, and not limitation, consider a user walking through a mall with his mobile phone. The phone can publish a first message stream comprising location data and the mall can publish a second message stream comprising advertisements. The first and the second message streams can be combined to produce a new stream to which the user can subscribe, which can then provide relevant advertisements as the user passes by a store. Further, note that the second message stream, provided by mall, can be composed from message streams comprising advertisements from each store in the mall.

In this example, loose coupling of concrete pub/sub systems is exploited as follows. First, there is a decoupling of systems in space, since concrete pub/sub systems can reside on a mall computer and/or a store computer each of which are separate from the a concrete pub/sub system on the phone. Further, there is decoupling in terms of control, as communication of location data and advertisements is asynchronous. Still further yet, there can be decoupling in time such that both publishers and subscribers need not both be running for everything to work. For example, if the phone were turned off the advertisements could still be streamed.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

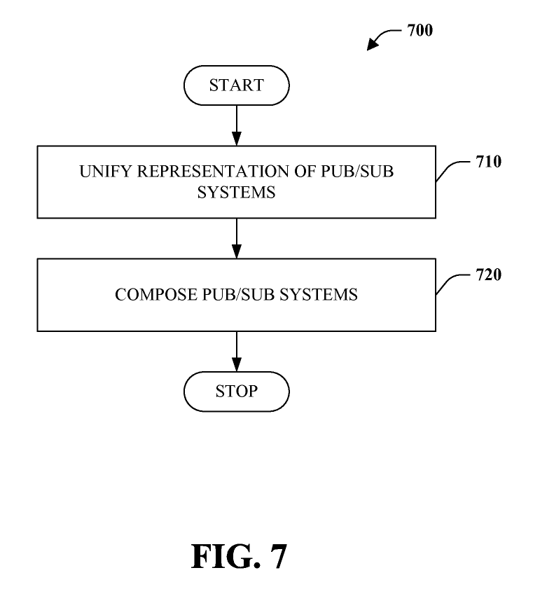

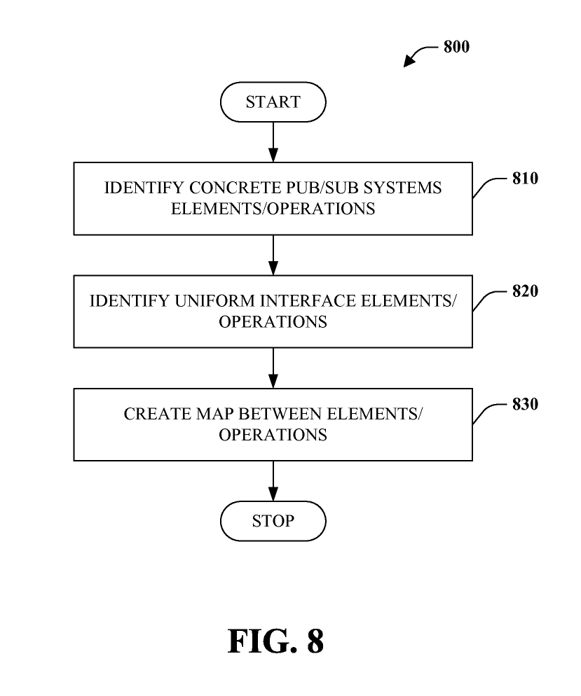

In view of the exemplary systems described supra, methodologies that may be implemented in accordance with the disclosed subject matter will be better appreciated with reference to the flow charts of FIGS. 7 and 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a method 700 of facilitating interoperability of pub/sub systems is illustrated. At reference numeral 710, representation of pub/sub systems is unified. Conventionally, pub/sub systems are independently produced by programmers who are comfortable with building concrete systems. A concrete pub/sub system is first implemented and subsequently modified to compete with other concrete pub/sub systems. This results in diversity amongst concrete pub/sub systems, which does not allow such systems to work together easily. A unified representation can take multiple implementations and layer a uniform representation on top of differences thereby allowing a consistent manner of interaction. Such a unified representation can be embodied as a uniform interface implemented over concrete pub/sub systems. At numeral 720, a pub/sub system is composed from a combination of one or more pub/sub systems or other systems that support the unified representation. In accordance with one embodiment, a general-purpose query mechanism (e.g., language-integrated query (LINQ) infrastructure) can be employed to enable combination of various complexities. For instance, various pub/sub systems can be mashed up into a single system. Additionally, the query mechanism can transform message streams from one or more concrete pub/sub systems to address any idiosyncrasies of the systems not addressed by unifying the representation, such as differences in stream format or data representation. Still further yet, it is to be appreciated that a composed pub/sub system can process received message stream(s) and itself be used to compose another yet another pub/sub system.

FIG. 8 illustrates a method 800 of transformation in accordance with an aspect of the disclosure. At reference numeral 810, operations of a concrete pub/sub system are identified. At numeral 820, operations of a uniform interface are identified. At reference numeral 830, a map is created between operation of the pub/sub system and uniform interface. This map can be utilized to bridge differences between the details of the pub/sub system and the uniform interface. Stated differently, the map enables use of the uniform interface to facilitate interaction with the concrete pub/sub system in a uniform fashion.

Despite the uniform interface, in one instance, differences may be present between streams of pub/sub systems. By way of example, and not limitation, Suppose a stream from a first pub/sub system has a time stamp identifying when a value in the stream was produced, but a second pub/sub system wants to know the difference in time between when values are produced (e.g., burstiness). In such an instance, the format of the stream from the first pub/sub system can be transformed to produce time differences (e.g., 30 seconds, ten minutes . . . ) rather than specific times (e.g., 1:00 p.m., 1:30 p.m. . . . ). Although not limited thereto, in one embodiment such a transformation can be effected by way of a query transformation.

Once pub/sub system interoperability is enabled, specific pub/sub systems can be thought of simply as fixed building blocks that can be easily combined in a variety of ways to produce other valuable systems. In one instance, a new pub/sub system can be developed that provides messages for other pub/sub systems. In another instance, down-stream systems can be positively impacted by up-stream combinations and processing and can perform so action based on stream content. By way of example, and not limitation, a business or consumer intelligence services can employ such technology in an attempt to correlate streams and identify trends. In another example, a telecommunication carrier that receives handshake signals from people whose phones use the carrier can use these signals to determine how towers can be repositioned or power can be modulated to towers to maximize efficiency. Similarly, cell phone signals can be monitored and used to infer traffic jams and attempt to reroute people to public transportation, for instance.

Further, as new concrete pub/sub systems are created interoperability becomes even more valuable. For example, search, such as World Wide Web search, can be turned into a pub/sub system. In this case, a single response to a query is not returned but rather notifications can be provided whenever something interesting happens regarding a search query. Consequently, the search query can correspond to a subscription and the results can be a stream of results. Further, a search pub/sub system can form a building block for other pub/sub system or end-user application, for instance.

The description above focused on independent pub/sub systems and employment of a unified representation such as a uniform interface over particular pub/sub systems. If, however, there is a connection between two or more pub/sub systems, such as a fast back channel for communication where the two more pub/sub systems communicate directly with each other, this can be exploited to enable efficient operation. In this case, combinations, for example can be performed by the two systems and the result can be converted into a unified/uniform representation such as an “IObservable.”

As used herein, the terms “component” and “system” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘A’ and ‘B’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

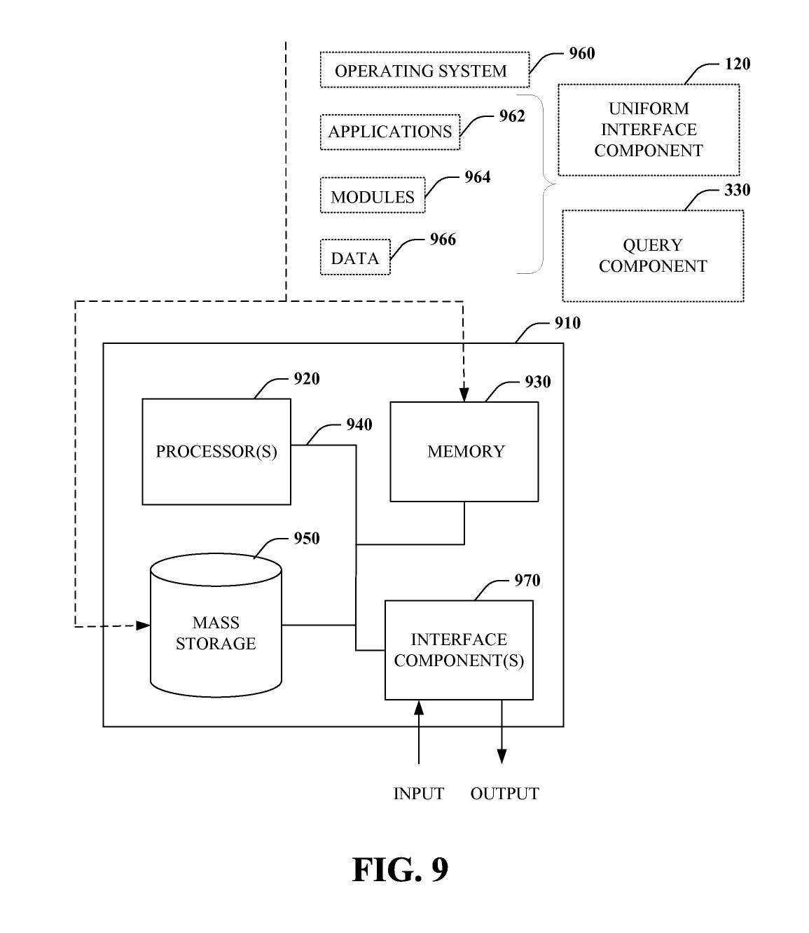

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, server, hand-held, programmable consumer or industrial electronics, set-top box, game system . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 910.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the uniform interface component 120 and query component 330, or portions thereof, can be, or form part, of an application 962, and include one or more modules 964 and data 966 stored in memory and/or mass storage 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, uniform interface component 120 and query component 330 and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910 through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
composing a message stream as a function of message streams from one or more publish/subscribe systems.

2. The method of claim 1 further comprises unifying interaction amongst the one or more publish/subscribe systems.

3. The method of claim 2 further comprises implementing a continuation-passing style interface over the one or more publish/subscribe systems.

4. The method of claim 1 further comprises transforming the message streams to a canonical format.

5. The method of claim 1, composing the message stream as a function of a query specified over the messages from the one or more publish/subscribe systems.

6. The method of claim 5, composing the message stream as a function of one or more general-purpose, programming-language-integrated, query operators.

7. The method of claim 5, the query is specified to address idiosyncrasies of the one or more publish/subscribe systems.

8. The method of claim 1, composing the message stream comprises composing two or more message streams from a single message stream.

9. The method of claim 1, performing an action based on content of the message stream.

10. A system, comprising:
a processor coupled to a memory, the processor configured to execute the following computer-executable components stored in the memory:
a first component configured to enable interaction with diverse publish/subscribe system implementations in a uniform manner.

11. The system of claim 10, the first component is configured to produce a message stream from two or more message streams from two or more diverse publish/subscribe system implementations.

12. The system of claim 10, the first component is configured to produce two or more message streams from a single message stream from one of the diverse publish/subscribe system implementations.

13. The system of claim 10, a query that defines the interaction with the diverse publish/subscribe system implementations.

14. The system of claim 13, the query comprises one or more general-purpose, programming-language-integrated, query operators.

15. The system of claim 13, the query accounts for differences between stream formats.

16. The system of claim 10, the first component is configured to convert a stream produced by two or more publish/subscribe system implementations that communicate with each other into a uniform representation.

17. A computer-readable storage medium having instructions stored thereon that enables at least one processor to perform the following acts:
generating a message stream as a function of interaction with one or more publish/subscribe systems by way of a uniform interface.

18. The computer-readable storage medium of claim 17, generating the message stream based on a query, comprising one or more general-purpose, programming-language-integrated, query operators.

19. The computer-readable storage medium of claim 18, generating the message based on a query that accounts for differences in stream formats.

20. The computer-readable storage medium of claim 18 further comprises generating multiple message streams from a single message stream provided by one or the one or more publish/subscribe systems.
